(19) United States
(12) Patent Application Publication
(10) Pub. No.: US 2014/0060696 A1
(43) Pub. Date: Mar. 6, 2014

(54) DRUG SOLUTION TRANSFER METHOD AND DRUG SOLUTION TRANSFER APPARATUS

(71) Applicant: Panasonic Corporation, Osaka (JP)

(72) Inventors: Akinobu Okuda, Nara (JP); Akihiro Ohta, Osaka (JP); Yuki Takenaka, Shiga (JP); Tsuyoshi Tojo, Osaka (JP); Tohru Nakamura, Osaka (JP); Akira Higuchi, Osaka (JP)

(21) Appl. No.: 13/983,871

(22) PCT Filed: Oct. 15, 2012
(86) PCT No.: PCT/JP2012/006591

§ 371 Date: Aug. 6, 2013

(30) Foreign Application Priority Data
Oct. 26, 2011 (JP) 2011-234876

(51) Int. Cl. A61J 1/20

(52) U.S. Cl. CPC A61J 1/2096
USPC 141/27

(57) ABSTRACT

A drug solution transfer method includes step S1 of inserting a needle into a drug solution container through a rubber stopper and sucking drug solution in the drug solution container, step S2 of checking whether or not a solution collection inlet at a tip of the needle has shifted into the rubber stopper upon extracting the needle from the drug solution container, step S3 of pulling a plunger of a syringe provided with the needle so that an inside of the needle and an inner space of the syringe have negative pressure, and step S4 of relatively shifting the needle along with the syringe to be distant from the drug solution container so as to extract the solution collection inlet of the needle from the rubber stopper.

### TECHNICAL FIELD

The present invention relates to a drug solution transfer method and a drug solution transfer apparatus for transferring drug solution such as an injection drug into a syringe in medical care and the like.

### BACKGROUND ART

Upon administration of drug solution to an inpatient at a hospital or the like, several types of drug solutions are extracted from a plurality of drug solution containers and mixed together in many cases. In general, drug solution is extracted from a drug solution container manually by a nurse, a pharmacist, or the like, and the drug solution is sucked with use of an injection needle or the like that is manually inserted into the drug solution container. Suction of drug solution of high viscosity such as glucose in an infusion solution bag or suction of drug solution from a vial container requiring adjustment of internal pressure need power of at least certain intensity. Mixing such drugs is quite a burden to a nurse or a pharmacist. Like an anticancer drug, some of drugs used in hospitals and the like need to be safely handled with specific care. There are demands for development of drug solution transfer methods and drug solution transfer apparatuses that achieve safe handling with a small workload.

After mixing drugs in a drug solution container such as an infusion solution bag or a vial container with use of a syringe or the like, when a needle is extracted from the drug solution container, there possibly occurs a phenomenon that the drug solution leaks from a rubber stopper of the drug solution container or a tip of the needle of the syringe (hereinafter, referred to as “spill”). Such spill occurs in a case where internal pressure of the drug solution container or internal pressure of the syringe is higher than the atmospheric pressure. When the rubber stopper of the drug solution container and the tip of the needle of the syringe are separated from each other, the drug solution inside leaks to outside at the atmospheric pressure, resulting in occurring the spill.

There is a conventional measure for preventing spill by controlling internal pressure of an injection port used for injecting drug solution so as to be equal to the atmospheric pressure (see Patent Literature 1, for example).

FIG. 5 is a sectional view of such a conventional injection port. As shown in FIG. 5, an injection port 1 seals a drug solution inlet 4 of a main body 2 by means of an elastic member 5, and has a tube 6 that is in communication with an inner space 3 of the main body 2. The inner space 3 is provided, at the bottom, with a pressure adjuster 9 that includes a hard plate 7 and a stretchable member 9a located between the plate 7 and a bottom surface 8 of the inner space 3.

In FIG. 5, when a needle 10 is extracted from the elastic member 5, a part of the elastic member 5 shifts upward along with the needle 10 and the inner space 3 is thus increased in volume. Then, the inner space 3 is decreased in pressure. In this case, blood sucked toward the inner space 3 may flow into a lumen 12 of a catheter 11. The conventional injection port 1 prevents such a flow of blood by stretching the stretchable member 9a and increasing the volume of the pressure adjuster 9 so as to suppress increase in volume of the inner space 3 and prevent decrease in pressure of the inner space 3.

FIG. 6 is a partial sectional view showing a state where drug solution 14 is sucked from a drug solution container 13 with use of the conventional injection port 1. The drug solution container 13 is located at the drug solution inlet 4 of the injection port 1. In the example of FIG. 6, a needle 15 is used in place of the tube 6. The needle 15 is attached to a tip of a syringe (not shown). The needle 15 is inserted from below near a side portion 9b of the pressure adjuster 9 so as to penetrate a rubber stopper portion 9c, the pressure adjuster 9, the inner space 3, and the elastic member 5, and then to penetrate a rubber stopper (not shown) of the drug solution container 13. When the needle 15 is extracted from the rubber stopper and the injection port 1 after the drug solution 14 is sucked, the tip of the needle 15 is stopped in the inner space 3 of the injection port 1. The leaking drug solution 14 is sucked once in the inner space 3 and the needle 15 is then extracted from the injection port 1. In this manner, it is possible to prevent the phenomenon of spill that the drug solution 14 leaks out of the needle 15 of the syringe.

### CITATION LIST

### Patent Literature

Patent Literature 1: JP 07-171217 A

### SUMMARY OF INVENTION

### Technical Problem

However, the injection port 1 described above needs to be attached to the drug solution container 13 or the needle 15 of the syringe in order to transfer drug solution.

The present invention has been achieved to solve this problem, and it is an object of the present invention to provide a drug solution transfer method and a drug solution transfer apparatus that prevent spill with no use of any component such as an injection port, which is to be attached to a drug solution container or a needle of a syringe. The drug solution transfer method and the drug solution transfer apparatus realize safe handling of drug solution.

### Solution to Problem

In order to achieve the object mentioned above, a drug solution transfer method according to the present invention comprises: pulling a plunger of a syringe in a state where a needle of the syringe penetrates a rubber stopper of a drug solution container to suck drug solution from the drug solution container into the syringe;

relatively shifting the drug solution container and the syringe to be distant from each other and then stopping to locate a solution collection inlet at a tip of the needle inside the rubber stopper;

pulling the plunger in a state where the solution collection inlet is located inside the rubber stopper so that an inner space of the syringe has negative pressure; and then

relatively shifting the drug solution container and the syringe to be distant from each other so as to extract the solution collection inlet of the needle from the rubber stopper.

A drug solution transfer apparatus according to the present invention comprises: a first retainer that retains a drug solution container provided with a rubber stopper;

a second retainer that retains a syringe provided with a needle;

a first shifter that shifts the first retainer or the second retainer;

a second shifter that shifts a plunger of the syringe; and

a controller that controls the first shifter and the second shifter independently from each other; wherein

the controller controls such that

the second shifter shifts the plunger in a state where the needle penetrates the rubber stopper so that drug solution is sucked from the drug solution container into the syringe,

the drug solution container and the syringe are relatively shifted to be distant from each other and stopped so as to locate a solution collection inlet at a tip of the needle inside the rubber stopper,

the second shifter pulls the plunger in the state where the solution collection inlet is located inside the rubber stopper so that an inner space of the syringe has negative pressure, and then

the drug solution container and the syringe are relatively shifted to be distant from each other so that the needle is extracted from the drug solution container.

### Effects of Invention

The present invention provides the drug solution transfer method and the drug solution transfer apparatus that prevent spill with no use of any additional component to be attached to the drug solution container or the needle of the syringe and thus realize safe handling of drug solution.

### BRIEF DESCRIPTION OF THE DRAWINGS

These and other objects and features of the present invention are apparent from the following description in connection with the embodiments depicted in the accompanying drawings. In these drawings,

FIG. 1A is a schematic configuration view showing a part of a drug solution transfer apparatus, according to a first embodiment of the present invention;

FIG. 1B is an exemplary schematic configuration view of a part of a controller and the like of the drug solution transfer apparatus, according to the first embodiment of the present invention;

FIG. 2 is a flowchart of a drug solution transfer method according to the first embodiment of the present invention;

FIG. 3A is a sectional view specifically showing a part of the drug solution transfer apparatus in a state in step S1 serving as one example of the suction step in the drug solution transfer method, according to the first embodiment of the present invention;

FIG. 3B is a sectional view specifically showing a part of the drug solution transfer apparatus in a state in step S2 serving as one example of the airtight check step in the drug solution transfer method, according to the first embodiment of the present invention;

FIG. 3C is a sectional view specifically showing a part of the drug solution transfer apparatus in another state in step S2 serving as one example of the airtight check step in the drug solution transfer method, according to the first embodiment of the present invention;

FIG. 3D is a sectional view specifically showing a part of the drug solution transfer apparatus in a state in step S3 serving as one example of the negative pressurization step in the drug solution transfer method, according to the first embodiment of the present invention;

FIG. 3E is a sectional view specifically showing a part of the drug solution transfer apparatus in a state in step S4 serving as one example of the extraction step in the drug solution transfer method, according to the first embodiment of the present invention;

FIG. 4 is a detailed flowchart of the drug solution transfer method according to the first embodiment of the present invention;

FIG. 5 is a sectional view of a conventional injection port;

FIG. 6 is a partial sectional view showing a state of sucking drug solution from a drug solution container with use of the conventional injection port;

FIG. 7A is a sectional view specifically showing a part of the drug solution transfer apparatus in a state in step S23 serving as one example of the shift stop step in the drug solution transfer method, according to the first embodiment of the present invention; and

FIG. 7B is a sectional view specifically showing a part of the drug solution transfer apparatus in the state in step S23 serving as one example of the shift stop step in the drug solution transfer method, according to a modification example of the first embodiment of the present invention.

### DESCRIPTION OF EMBODIMENTS

Embodiments of the present invention are described below with reference to the drawings. Same constituent elements are denoted by same reference signs and are not described in some cases. The drawings typically depict to mainly include the constituent elements for the purpose of easier comprehension.

### First Embodiment

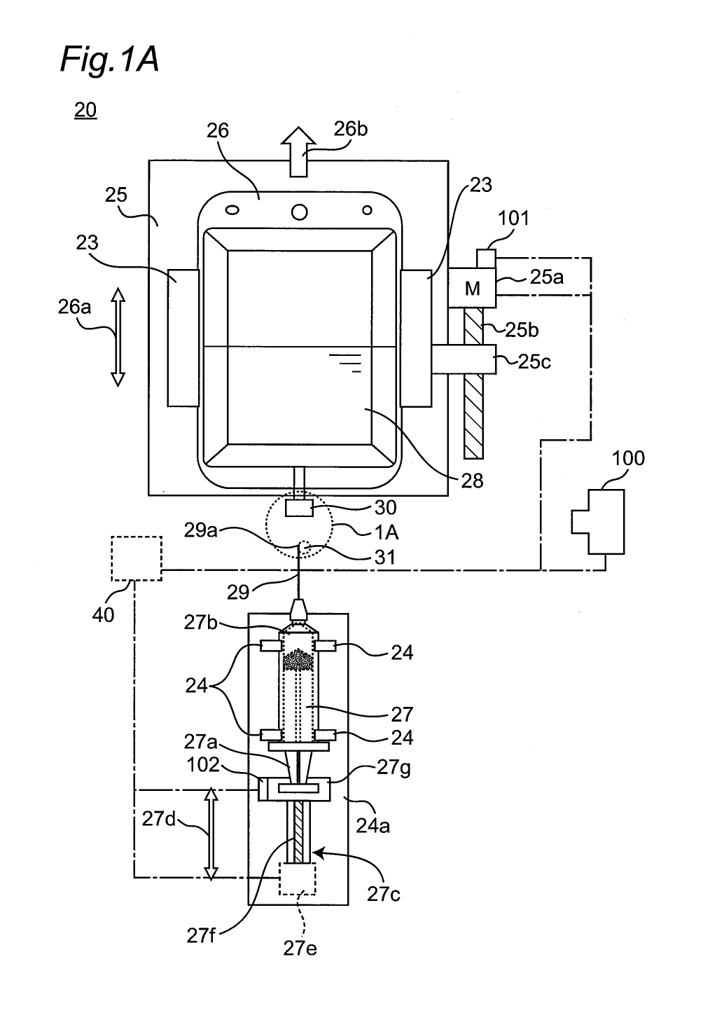

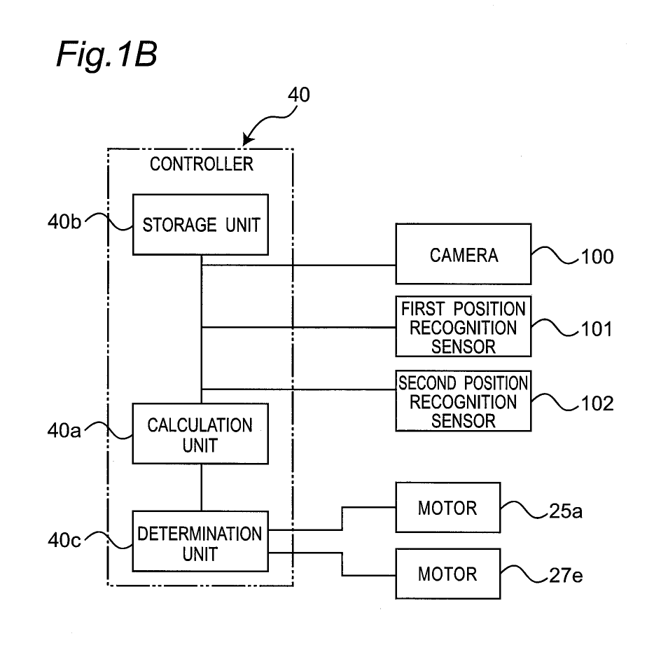

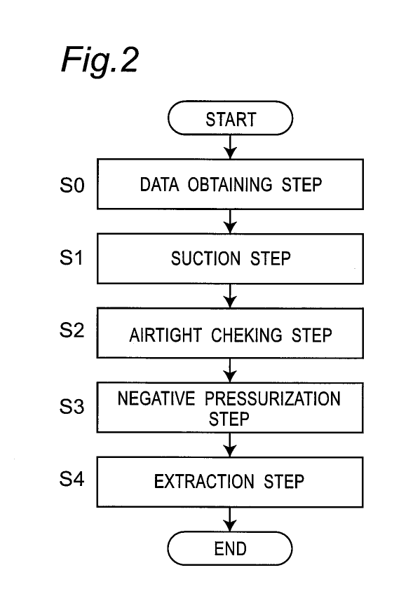

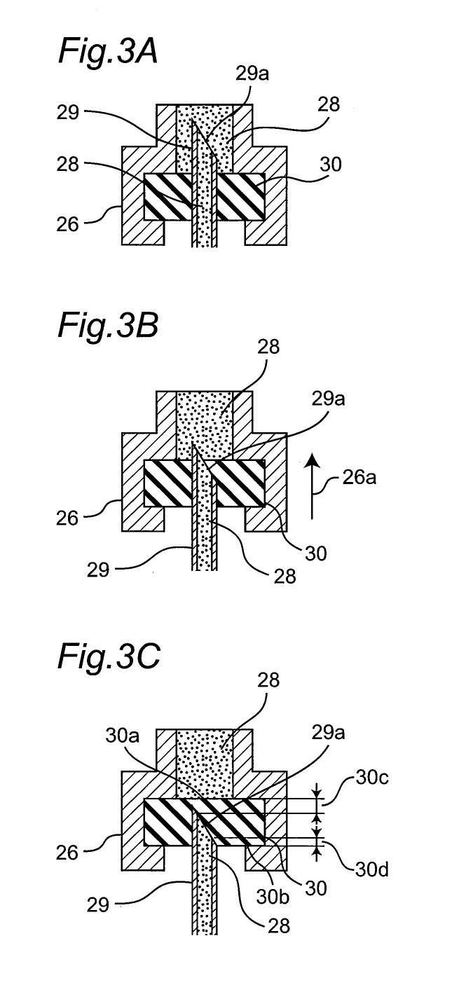

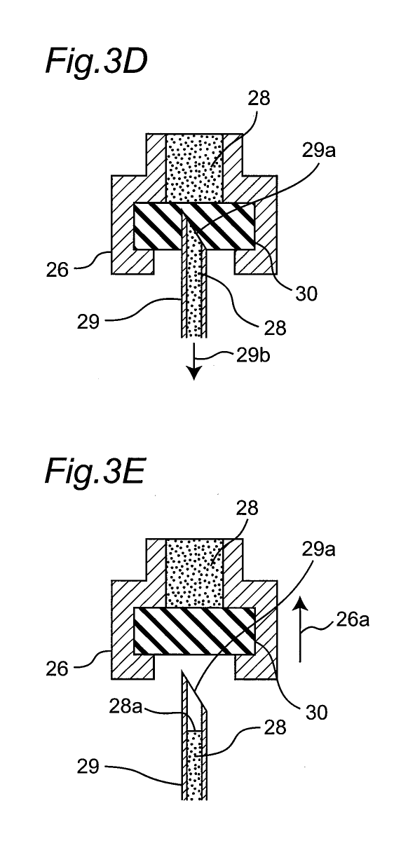

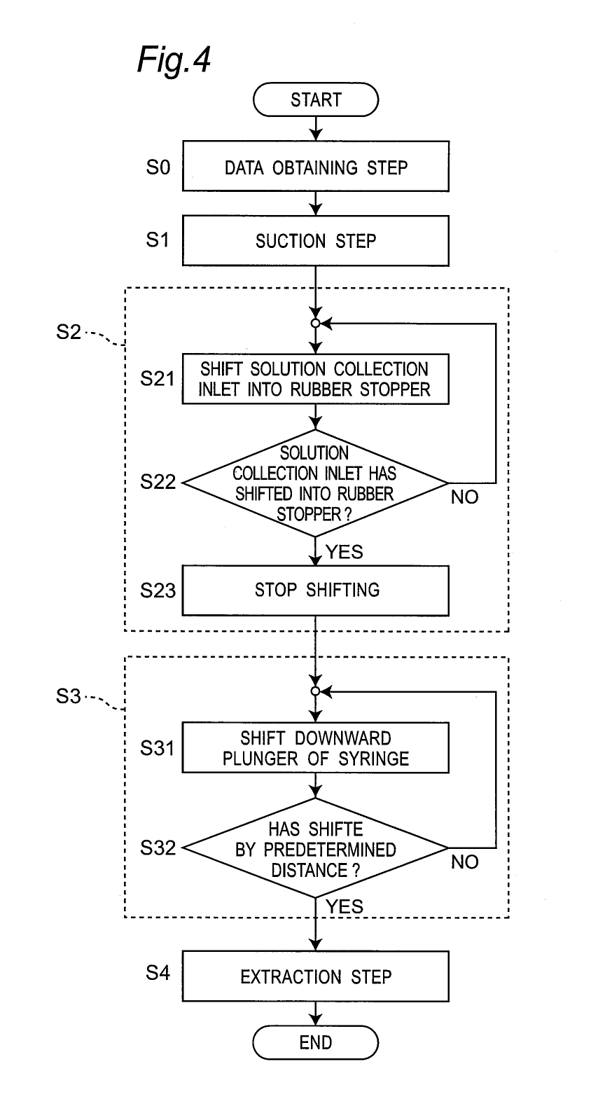

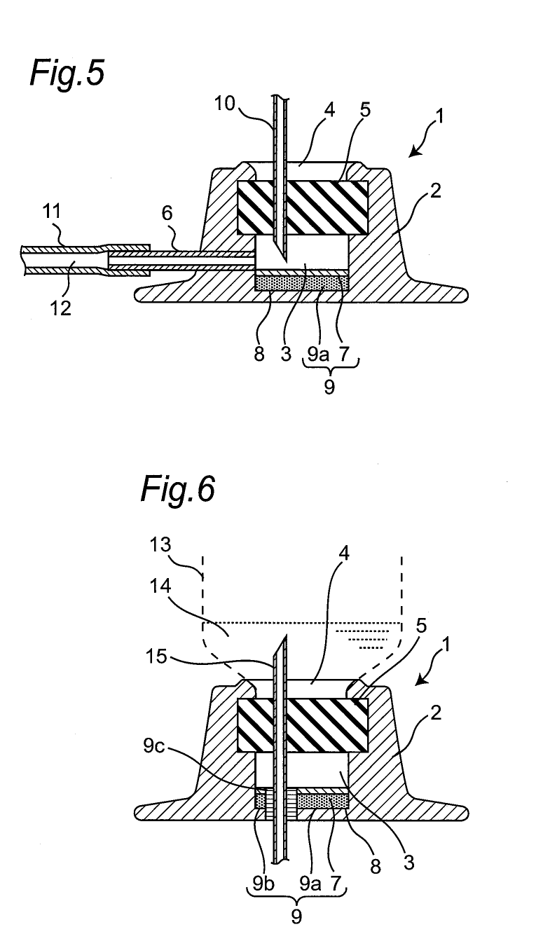

FIG. 1A is a schematic configuration view showing a part of a drug solution transfer apparatus 20 according to the first embodiment of the present invention. FIG. 1B is an exemplary schematic configuration view of a controller and the like of the drug solution transfer apparatus according to the first embodiment of the present invention. FIG. 2 is a flowchart of a drug solution transfer method according to the first embodiment of the present invention. FIGS. 3A to 3E are sectional views showing a part of the drug solution transfer apparatus 20 in states in the steps in the drug solution transfer method, according to the first embodiment of the present invention. FIG. 4 is a detailed flowchart of the drug solution transfer method according to the first embodiment of the present invention.

As shown in FIG. 1A, the drug solution transfer apparatus 20 according to the first embodiment includes a first retainer 23 retaining a drug solution container 26, second retainers 24 retaining a syringe 27, a first shifter 25 for shifting the first retainer 23 upward and downward, and a controller 40 for controlling operation of each of these portions. The first retainer 23 serves as one example of a container retainer. The second retainers 24 serve as one example of syringe retainers. The first shifter 25 serves as one example of a container shifter for shifting a container. The drug solution transfer apparatus 20 according to the first embodiment initially causes drug solution 28 to be sucked from the drug solution container into the syringe 27. The drug solution transfer apparatus 20 according to the first embodiment then causes a plunger 27a of the syringe 27 to shift downward for negative pressurization in a state where a solution collection inlet 29a at a tip of a needle 29 of the syringe is located inside a rubber stopper 30 of the drug solution container 26 upon extracting the needle 29 from the drug solution container 26. In this state, the first retainer 23 retains the drug solution container 26 in an inverted posture. As one example, the rubber stopper 30 has a rectangular shape in cross section. The drug solution container 26 has an opening that receives the rubber stopper 30, and the opening has an outer shape in the inverted T form (convex shape) as shown in FIGS. 1A and 3A to 3E.

According to the first embodiment, an inner space 27b of the syringe 27 is caused to have negative pressure by shifting the plunger 27a in a state where the solution collection inlet 29a is located inside the rubber stopper 30. Such negative pressure in the inner space 27b of the syringe 27 prevents the phenomenon of spill that the liquid drug solution 28 leaks from the rubber stopper 30 or the solution collection inlet 29a. The negative pressure in the inner space 27b of the syringe 27 causes the drug solution 28 in the vicinity of the solution collection inlet 29a to be sucked by the syringe 27. As a result, spill of the drug solution 28 out of the syringe 27 can be prevented in the first embodiment.

As the material for the rubber stopper 30, butyl, chlorinated butyl, butadiene, or isoprene may be used.

More specifically, according to the first embodiment, such control on operation of the drug solution transfer apparatus 20 can prevent spill with no need for any additional component that is conventionally attached to the drug solution container 26 or the syringe 27, so that the drug solution can be handled safely. Particularly in a case of handling drug solution such as an anticancer drug, in addition to avoid spill, the conventional method requires care also upon attaching and detaching an additional component. The control according to the first embodiment does not need such a component and realizes safe handling of drug solution.

Detailed next is operation of the drug solution transfer apparatus 20 according to the first embodiment in detail. Exemplified herein is the drug solution transfer apparatus 20 as shown in FIG. 1A, in which the drug solution container 26 is located vertically in the upper portion and the syringe 27 is located coaxially and vertically below the drug solution container 26.

The syringe 27 is provided at the tip thereof with the needle 29. The syringe 27 is retained by the two upper and lower second retainers 24 such that the tip of the needle 29 is directed substantially vertically upward. The second retainers 24 are supported by a syringe base 24a. The plunger 27a of the syringe 27 is freely shifted upward and downward (vertically) along an arrow 27d by a second shifter 27c that is provided to the syringe base 24a. The second shifter 27c serves as one example of a plunger shifter for shifting the plunger. For example, the second shifter 27c includes a motor 27e, a ball screw shaft 27f, and a movable plate 27g. The motor 27e has a rotary shaft that rotates forward or backward. The ball screw shaft 27f rotates forward or backward along with the forward or backward rotation of the rotary shaft of the motor 27e. The movable plate 27g is coupled to the plunger 27a and is engaged with the ball screw shaft 27f so as to shift vertically upward or downward along with the plunger 27a. The motor 27e functions as one example of a shifter drive device, and is controlled and driven by the controller 40 so that the rotary shaft rotates forward or backward. When the motor 27e is controlled and driven by the controller 40, the plunger 27a is shifted upward or downward along the arrow 27d so as to suck the drug solution 28 from the drug solution container 26 into the inner space 27b of the syringe 27 or discharge the drug solution 28 from the inner space 27b into the drug solution container 26. The second retainers 24, the movable plate 27g of the plunger 27a, and the like are movably attached to the syringe base 24a.

As the drug solution container 26, can be used a vial container or an infusion solution bag that preliminarily contains drug solution. In the first embodiment, the infusion solution bag is used as one example of the drug solution container 26. The drug solution container 26 is retained by the first retainer 23 in an inverted state where the rubber stopper 30 is located vertically below. The rubber stopper 30 is a part of a path used for transferring the drug solution 28. The first retainer 23 is fixed to the first shifter 25. For example, the first shifter 25 includes a motor 25a, a ball screw shaft 25b, and a movable plate 25c. The motor 25a has a rotary shaft that rotates forward or backward. The ball screw shaft 25b rotates forward or backward along with the forward or backward rotation of the rotary shaft of the motor 25a. The movable plate 25c is coupled to the first retainer 23 and is engaged with the ball screw shaft 25b so as to shift vertically upward or downward along with the first retainer 23. The motor 25a functions as one example of a shift mechanism drive device, and is controlled and driven by the controller 40 so that the rotary shaft rotates forward or backward. When the motor 25a is controlled and driven by the controller 40, the movable plate 25c and the first retainer 23 are shifted upward or downward along an arrow 26a (vertically) so that the rubber stopper 30 of the drug solution container 26 shifts so as to be closer to or distant from the needle 29 of the syringe 27 located vertically below.

When transferring the drug solution 28 from the drug solution container 26 into the syringe 27, in general, the drug solution container 26 is shifted vertically downward along the arrow 26a by the first shifter 25. The needle 29 of the syringe 27 then penetrates, from vertically below, the rubber stopper 30 of the drug solution container 26, and the solution collection inlet 29a of the needle 29 reaches a region where the drug solution 28 is contained in the drug solution container 26. Subsequently, the plunger 27a of the syringe 27 is pressed downward by the second shifter 27c, so that a predetermined amount of the drug solution 28 in the drug solution container 26 is sucked into the inner space 27b of the syringe 27 through the needle 29.

If the needle 29 is extracted quickly from the drug solution container 26 upon completion of suction of the drug solution 28, as indicated by a broken line in an area 1A in FIG. 1A, a part of the drug solution 28 leaks out of the solution collection inlet 29a at the tip of the needle 29 of the syringe 27 as a droplet 31. Such a phenomenon that a part of the drug solution 28 leaks out of the solution collection inlet 29a is referred to as spill.

In order to prevent such spill, in the drug solution transfer apparatus 20 according to the first embodiment, the controller 40 controls so that the drug solution container 26 is shifted vertically upward by the first shifter 25 upon extraction of the needle 29 from the drug solution container 26. According to the first embodiment, the controller 40 controls the first shifter 25 so that the rubber stopper 30 once stops movement with respect to the needle 29 in a state where the solution collection inlet 29a at the tip of the needle 29 is located inside the rubber stopper 30. The controller 40 controls so that the inner space of the syringe 27 and the inside of the needle 29 have negative pressure. More specifically, in order to have negative pressure, in the state where the solution collection inlet 29a at the tip of the needle 29 is located inside the rubber stopper 30, the plunger 27a of the syringe 27 is shifted downward by the second shifter 27c so as to increase the volume in the inner space 27b of the syringe 27. The increased volume causes each of the pressure in the needle 29 and the pressure in the inner space 27b of the syringe 27 to be lower than the atmospheric pressure, so that the inside of the needle 29 and the inner space 27b of the syringe 27 can have negative pressure.

Under the negative pressure, the controller 40 controls to shift vertically upward again the first shifter along an arrow 26b, so that the needle 29 and the syringe 27 are shifted vertically downward relatively to the drug solution container 26 and the solution collection inlet 29a at the tip of the needle 29 is extracted from the rubber stopper 30. The inside of the needle 29 has negative pressure immediately after the needle 29 is extracted from the rubber stopper 30. Out of the drug solution 28 left inside the needle 29, the drug solution 28 in the vicinity of the solution collection inlet 29a directed upward is sucked into the inner space 27b of the syringe 27 due to the internal negative pressure. According to the first embodiment, the phenomenon of spill that the drug solution 28 leaks out of the rubber stopper 30 and the needle 29 is prevented, and the drug solution can be handled safely.

The controller 40 includes a calculation unit 40a, a storage unit 40b, and a determination unit 40c, and controls and drives drive devices such as the motors.

The storage unit 40b preliminarily stores a database including data on the position of the rubber stopper 30, data on the thickness of the rubber stopper 30, and data on the position of the tip of the solution collection inlet 29a at the tip of the needle 29, for each type of the rubber stopper 30, the needle 29, or the drug solution container 26. The storage unit 40b may not preliminarily store these pieces of data, but can obtain necessary data with use of a camera 100, first and second sensors 101 and 102 serving as one example of shift amount detectors, and the like, and store the data thus obtained. The first and second sensors 101 and 102 exemplify first and second position recognition sensors, respectively.

The calculation unit 40a obtains necessary data from the storage unit 40b, and obtains, from the camera 100 and the first and second sensors 101 and 102, positional information on the rubber stopper 30 of the drug solution container 26, positional information on the tip of the solution collection inlet 29a at the tip of the needle 29, and positional information on the plunger 27a. On the basis of these pieces of information thus obtained, the calculation unit 40a performs calculation in each of the steps to be described later to obtain a relative position of the solution collection inlet 29a with respect to the rubber stopper 30 and a shift amount of the plunger 27a.

The determination unit 40c determines end (completion) of operation in each of the steps to be described later on the basis of the result of the calculation by the calculation unit 40a, and outputs a drive stop signal to a drive device such as the motor 25a or 27e.

Described next with reference to FIGS. 2 and 3A to 3E are schematic states before and after the needle 29 passes through the rubber stopper 30 and is extracted from the drug solution container 26.

As shown in FIG. 2, the drug solution transfer method according to the first embodiment mainly includes step S1 serving as one example of the suction step, step S2 serving as one example of the airtight check step, step S3 serving as one example of the negative pressurization step, and step S4 serving as one example of the extraction step.

Prior to step S1, there is step S0 serving as one example of the data obtaining step. In step S0, the calculation unit 40a of the controller 40 obtains, from the various sensors, data on the position of the rubber stopper 30 of the drug solution container 26, data on the thickness of the rubber stopper 30, and data on the position of the tip of the solution collection inlet 29a at the tip of the needle 29. More specifically, as shown in FIG. 1A, these sensors include the camera 100 that is attached to a front or side surface of the syringe 27 and the first sensor 101 located at the first shifter 25 for the first retainer 23. The camera 100 and the first sensor 101 detect the relative position of the solution collection inlet 29a with respect to the position and the thickness of the rubber stopper 30, and data thus obtained is stored in the storage unit 40b of the controller 40.

Next in step S1 serving as one example of the suction step, the needle 29 (FIG. 3A) penetrates the rubber stopper 30 and is inserted into the drug solution container 26 to suck the predetermined amount of the drug solution 28 in the drug solution container 26. The controller 40 controls and drives the motor 25a of the first shifter 25 so that the drug solution container 26 is shifted downward and thus the needle 29 penetrates the rubber stopper 30 and is inserted into the drug solution container 26. The controller 40 also controls and drives the motor 27e of the second shifter 27c so that the plunger 27a of the syringe 27 is shifted downward and thus the predetermined amount of the drug solution 28 is sucked.

Next in step S2 serving as one example of the airtight check step, when the drug solution container 26 is shifted upward along the arrow 26a and the needle 29 is extracted from the drug solution container 26 (see FIG. 3B), the solution collection inlet 29a at the tip of the needle 29 is shifted into the rubber stopper 30 and is stopped (see FIG. 3C), to check the airtight state of the inner space 27b of the syringe 27. The controller 40 controls and drives the motor 25a of the first shifter 25 so that the drug solution container 26 is shifted upward and thus the needle 29 is extracted from the drug solution container 26.

Next in step S3 serving as one example of the negative pressurization step, the controller 40 controls and drives the motor 27e of the second shifter 27c and the plunger 27a of the syringe 27 provided with the needle 29 is pulled so as to cause the inner space 27b of the syringe 27 to have negative pressure (see FIG. 3D).

Next in step S4 serving as one example of the extraction step, the controller 40 controls and drives again the motor 25a of the first shifter 25 so that the drug solution container 26 is further shifted upward and the needle 29 is relatively shifted along with the syringe 27 so as to be distant from the drug solution container 26. The solution collection inlet 29a of the needle 29 is accordingly extracted from the rubber stopper 30 (see FIG. 3E).

Described next with reference to FIGS. 3A to 3E are the configuration around the rubber stopper 30 and movement of the needle 29 in each of steps S1 to S4 of FIG. 2. The views showing the states of the steps S1 to S4 in FIGS. 3A to 3E are partial sectional views each showing the configuration around the rubber stopper 30 and the movement of the needle 29 in a state in corresponding one of steps S1 to S4 of FIG. 2.

Step S1 in FIG. 2 is described with reference to FIG. 3A. As shown in FIG. 3A, the needle 29 vertically penetrates and is inserted into the rubber stopper 30 of the drug solution container 26. This needle 29 sucks the predetermined amount of the drug solution 28 from the drug solution container 26 into the inner space 27b of the syringe 27 (step S1). The drug solution 28 thus sucked through the solution collection inlet 29a of the needle 29 passes through the needle 29 and is sucked into the inner space 27b of the syringe 27 (see FIG. 1A). At this stage, the drug solution 28 sucked into the needle 29 is pressurized by the weight of the drug solution 28 contained in the drug solution container 26 located vertically above and thus has positive pressure slightly higher than the atmospheric pressure.

Step S2 in FIG. 2 is described next with reference to FIG. 3B. Upon completion of the suction of the predetermined amount of the drug solution 28 into the syringe 27 in step S1, as shown in FIG. 3B, the drug solution container 26 is shifted vertically upward along the arrow 26a with respect to the syringe 27. The drug solution container 26 is shifted until the solution collection inlet 29a at the tip of the needle 29 is completely covered with the rubber stopper 30, and thereafter, as shown in FIG. 3C, the drug solution container 26 is stopped. At this stage, it is checked whether or not the solution collection inlet 29a at the tip of the needle 29 is completely sealed by the rubber stopper 30 and the needle 29 and the inner space 27b of the syringe 27 are in the airtight state (step S2). How to determine (check) the position to stop the drug solution container 26 is to be detailed later.

Step S3 in FIG. 2 is described next with reference to FIG. 3D. The plunger 27a of the syringe 27 is pulled vertically downward along an arrow 29b shown in FIG. 3D. The plunger 27a can be pulled by a small distance. The plunger 27a is preferably pulled by a distance approximate to one scale of the syringe 27. The plunger 27a thus pulled increases the volume of the inside of the needle 29 and the volume of the inner space 27b of the syringe 27 that are made airtight temporarily in step S2. Due to the increased volumes of the spaces, the needle 29 and the inner space 27b of the syringe 27 have negative pressure (step S3).

Step S4 in FIG. 2 is described next with reference to FIG. 3E. After realizing the negative pressure state in step S3, the needle 29 is relatively shifted along with the syringe 27 so as to be distant from the drug solution container 26, so that the solution collection inlet 29a of the needle 29 is extracted from the rubber stopper 30 (step S4). At this stage, as shown in FIG. 3E, the solution collection inlet 29a of the needle 29 exits the rubber stopper 30. The inside of the needle 29 and the inner space 27b of the syringe 27 are made to have negative pressure (lower than the atmospheric pressure) in step S3. Thus, a liquid level 28a of the drug solution 28 in the needle 29 is pressed by the atmosphere and is shifted downward so as to be distant from the solution collection inlet 29a. Thus, by performing step S4 after step S3, the drug solution 28 in the vicinity of the solution collection inlet 29a at the tip of the needle 29 is sucked into the needle 29.

According to the first embodiment, it is possible to reliably prevent the phenomenon (spill) that the drug solution 28 leaks out of the solution collection inlet 29a in this manner, and thus the drug solution can be handled safely. As mentioned earlier, the first embodiment employs no additional component to be attached to the drug solution container 26 or the syringe 27 (needle 29) in order to reliably prevent spill. The first embodiment thus realizes safe transfer of the drug solution with no use of any additional component to be attached to the drug solution container 26 or the syringe 27 (needle 29).

Described next with reference to FIG. 4 is an overall flow of the drug solution transfer method according to the first embodiment.

FIG. 4 is a flowchart detailing the respective steps of the flowchart in FIG. 2 in the drug solution transfer method according to the first embodiment. Step S0 in FIG. 4 corresponds to step S0 in FIG. 2, step S1 in FIG. 4 corresponds to step S1 in FIG. 2, steps S21 to S23 in FIG. 4 correspond to step S2 in FIG. 2, steps S31 and S32 in FIG. 4 correspond to step S3 in FIG. 2, and step S4 in FIG. 4 corresponds to step S4 in FIG. 2.

Initially in step S0 of FIG. 4, the various sensors detect data on the position and the thickness of the rubber stopper 30 of the drug solution container 26 and data on the position of the tip of the solution collection inlet 29a at the tip of the needle 29. The calculation unit 40a of the controller 40 obtains these pieces of data thus detected by the various sensors. More specifically, as shown in FIG. 1A, the camera 100 that is attached to the front or side surface of the syringe 27 and the first sensor 101 located at the first shifter 25 detect data on the relative position of the solution collection inlet 29a with respect to the position and the thickness of the rubber stopper 30, and such data is obtained by the calculation unit 40a of the controller 40.

Subsequently in step S1 of FIG. 4, the drug solution 28 is sucked from the drug solution container 26 into the syringe 27. At this state, on the basis of the information stored in the storage unit 40b, the controller 40 controls and drives the motor 27e of the second shifter 27c so that the plunger 27a of the syringe 27 is shifted downward to suck the predetermined amount of the drug solution 28 in the drug solution container 26. The controller 40 controls so that the plunger 27a is shifted downward from an initial position in correspondence with the predetermined amount of the drug solution 28. The storage unit 40b preliminarily stores, as the database, data on the position and the thickness of the rubber stopper 30 and data on the position of the tip of the solution collection inlet 29a at the tip of the needle 29, for each type of the rubber stopper 30, the needle 29, or the drug solution container 26.

Subsequent step S2 in FIG. 4 includes step S21 serving as one example of the drug solution container shift step, step S22 serving as one example of the shift completion check step, and step S23 serving as one example of the shift stop step. In step S21, the controller 40 controls and drives the motor 25a of the first shifter 25 to shift downward the drug solution container 26, so that the solution collection inlet 29a is relatively shifted with respect to the rubber stopper 30 as in FIGS. 3A to 3B. Subsequently in step S22, as shown in FIG. 3B, the controller 40 checks whether or not the solution collection inlet 29a has completely shifted into the rubber stopper 30. More specifically, according to the first embodiment, at this stage, the calculation unit 40a of the controller calculates to obtain the position of the solution collection inlet 29a in the rubber stopper 30 with use of the information on the relative position of the solution collection inlet 29a with respect to the position and the thickness of the rubber stopper 30 as imaged by the camera 100, and the information of the shift amount of the drug solution container 26 as detected by the first sensor 101 of the first shifter 25. On the basis of the position of the solution collection inlet 29a in the rubber stopper 30 thus obtained by the calculation unit 40a, the determination unit 40c of the controller 40 checks and determines whether or not the solution collection inlet 29a has completely shifted into the rubber stopper 30. If the determination unit 40c determines that the solution collection inlet 29a has completely shifted into the rubber stopper 30 on the basis of the position of the solution collection inlet 29a in the rubber stopper 30 thus obtained by the calculation unit 40a (if Yes in step S22), the procedure proceeds to step S23. The determination unit 40c transmits to the motor 25a of the first shifter 25 a drive stop signal for the motor 25a, so as to stop the motor 25a and keep the state where the solution collection inlet 29a at the tip of the needle 29 is completely sealed by the rubber stopper 30 as shown in FIG. 3C. Subsequently, the procedure proceeds to step S3.

On the other hand, if the determination unit 40c determines that the solution collection inlet 29a has not completely shifted into the rubber stopper 30 on the basis of the position of the solution collection inlet 29a in the rubber stopper 30 thus obtained by the calculation unit 40a (if No in step S22), the procedure returns to step S21. In this case, steps S21 and S22 are repeatedly conducted until the solution collection inlet 29a completely shifts into the rubber stopper 30.

For example, the rubber stopper 30 is 5 to 9 mm thick, and the solution collection inlet 29a of the needle 29 is at the height of 2 to 3 mm. In this exemplary case, in the state where the solution collection inlet 29a at the tip of the needle 29 is completely sealed by the rubber stopper 30 as shown in FIG. 3C, in order to reliably keep negative pressure, a gap (a second closing portion 30b) between the lower end of the rubber stopper 30 and the lower end of the solution collection inlet 29a has a length 30d of at least 1 mm, and a gap (a first closing portion 30a) between the upper end of the rubber stopper 30 and the upper end of the solution collection inlet 29a has a length 30c of at least 1 mm. The determination unit 40c of the controller 40 determines a time point when the length 30c of the gap (the first closing portion 30a) between the upper end of the rubber stopper 30 and the upper end of the solution collection inlet 29a reaches 1 mm, and transmits to the motor 25a of the first shifter 25 a drive stop signal for the motor 25a so as to stop the motor 25a. The first closing portion 30a serves as an upper side solution collection inlet closing portion, and the second closing portion 30b serves as a lower side solution collection inlet closing portion. In this manner, the controller 40 controls and drives a drive device such as the motor 25a so as to reliably perform subsequent operation such as negative pressurization.

Subsequent step S3 in FIG. 4 includes step S31 serving as one example of the plunger shift step and step S32 serving as one example of the shift completion check step. In step S31, as described earlier, the controller 40 controls so that the plunger 27a is shifted downward by the second shifter 27c. Subsequently in step S32, the determination unit 40c checks and determines whether or not the plunger 27a has shifted to a predetermined position on the basis of the position of the plunger 27a detected by the second sensor 102. As described earlier, the plunger 27a can be shifted by a small distance in step S31, preferably about one scale provided on the syringe 27.

If the determination unit 40c determines that the plunger 27a has shifted by the predetermined distance on the basis of the position of the plunger 27a detected by the second sensor 102 (if Yes in step S32), step S3 of negative pressurization is regarded as having been completed and the procedure proceeds to step S4. On the other hand, if the determination unit 40c determines that the plunger 27a has not shifted by the predetermined distance on the basis of the position of the plunger 27a detected by the second sensor 102 (if No in step S32), the procedure returns to step S31, and steps S31 and S32 are repeatedly conducted until the plunger 27a has shifted by the predetermined distance.

Subsequently in step S4 of FIG. 4, the motor 25a of the first shifter 25 shown in FIG. 3D is driven to relatively shift the solution collection inlet 29a so as to exit the rubber stopper 30, and the solution collection inlet 29a is retreated and extracted from the drug solution container 26 such as an infusion solution bag (see FIG. 3E). In step S4, the solution collection inlet 29a is left in the atmospheric pressure. According to the first embodiment, as shown in FIG. 3E, the drug solution 28 does not leak outside because the inside of the needle 29 and the inner space 27b of the syringe 27 have negative pressure. The first embodiment can prevent spill, and the drug solution 28 can be handled safely.

According to the first embodiment, the drug solution 28 is sucked into the inner space 27b of the syringe 27 from the drug solution container 26 in the inverted posture. The drug solution in the container can be thus sucked with no residue.

In the drug solution transfer method according to the first embodiment, spill is prevented by difference in pressure between the outside and the inside of the needle 29 and the inner space 27b of the syringe 27. Similar effects can be achieved in any posture regardless of whether the needle 29 and the syringe 27 are upright or inverted during suction.

According to the first embodiment, negative pressurization can be achieved even with use of the drug solution container 26 that is hard to be adjusted in pressure due to deformation thereof (e.g. a medical soft bag such as an infusion solution bag).

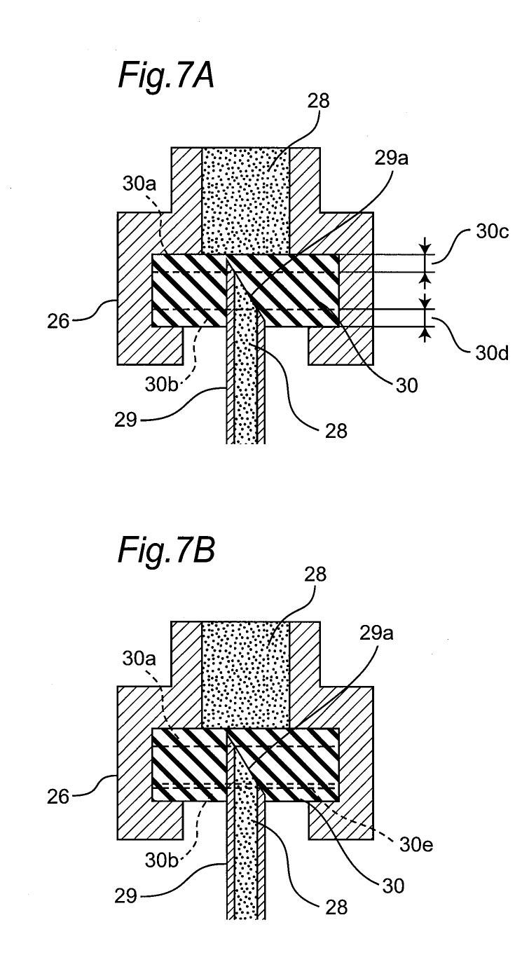

If the rubber stopper 30 is penetrated by another needle (conduct second penetration) after the needle 29 has once penetrated the rubber stopper 30 (conducted first penetration), in consideration of deterioration in elastic deformability of the rubber stopper 30, the length 30d of the portion (the second closing portion 30b) from the lower end of the rubber stopper 30 to the lower end of the solution collection inlet 29a can be made larger than that of the first penetration so as to further securely keep negative pressure. Similarly, upon third penetration, the length 30d of the second closing portion 30b can be made still larger than that of the second penetration so as to further securely keep negative pressure. For example, if the length 30d of the second closing portion 30b is 1 mm at the first penetration, the length 30d of the second closing portion 30b is set to 1.2 mm at the second penetration, and the length 30d of the second closing portion 30b is set to 1.4 mm at the third penetration. In other words, upon the second penetration, a third closing portion 30e (see FIG. 7B) can be provided between the lower end of the solution collection inlet 29a and the lower end of the rubber stopper 30 in addition to the second closing portion 30b of 1 mm (see FIG. 7A) so as to exceed the second closing portion 30b of 1 mm at the first penetration. The third closing portion 30e is an additional solution collection inlet closing portion. In this case, the third closing portion 30e is provided to have 0.2 mm at the second negative pressurization and the third closing portion 30e is also provided to have 0.2 mm (0.4 mm in total) at the third negative pressurization. FIG. 7B depicts the third closing portion 30e enlarged for the purpose of easier comprehension.

The drug solution container 26 can be of any type as long as it is elastically deformable. For example, the first embodiment exemplifies, as the drug solution container 26, a soft bag such as an infusion solution bag. Similar effects can be achieved even with use of a container of a different type, e.g. a soft bottle such as an infusion solution bottle, or a vial container.

According to the first embodiment, the first retainer 23 is shifted by the first shifter 25. Same relative movement can be achieved even in a case where the first retainer 23 is fixed and the second retainers 24 are shifted by the first shifter 25.

Any of the various embodiments and the modification examples having been described can be appropriately combined together to achieve the respective effects thereof.

### INDUSTRIAL APPLICABILITY

The drug solution transfer method and the drug solution transfer apparatus according to the present invention enable safe handling of drug solution, and can be thus applied to transfer of drug solution at hospitals, pharmacies, and the like.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A drug solution transfer method comprising:
pulling a plunger of a syringe in a state where a needle of the syringe penetrates a rubber stopper of a drug solution container to suck drug solution from the drug solution container into the syringe;
relatively shifting the drug solution container and the syringe to be distant from each other and then stopping to locate a solution collection inlet at a tip of the needle inside the rubber stopper;
pulling the plunger in a state where the solution collection inlet is located inside the rubber stopper so that an inner space of the syringe has negative pressure; and then
relatively shifting the drug solution container and the syringe to be distant from each other so as to extract the solution collection inlet of the needle from the rubber stopper.

2. The drug solution transfer method according to claim 1, wherein, when locating the solution collection inlet inside the rubber stopper, there is a solution collection inlet closing portion of at least 1 mm thick between a lower end of the solution collection inlet and a lower end of the rubber stopper, and there is a solution collection inlet closing portion of at least 1 mm thick between an upper end of the solution collection inlet and an upper end of the rubber stopper.

3. The drug solution transfer method according to claim 2, wherein, when another needle penetrates the rubber stopper after the needle once penetrates the rubber stopper, there is a solution collection inlet closing portion of at least 1 mm thick between the lower end of the solution collection inlet and the lower end of the rubber stopper.

4. The drug solution transfer method according to claim 1, wherein, upon relatively shifting the drug solution container and the syringe to be distant from each other and stopping so as to locate the solution collection inlet inside the rubber stopper,
an amount of relative shift between the drug solution container and the syringe so as to be distant from each other is detected, and
the solution collection inlet is located inside the rubber stopper in accordance with data on a position and a thickness of the rubber stopper and data on a position of the solution collection inlet preliminarily obtained, as well as the shift amount.

5. The drug solution transfer method according to claim 1, wherein
the drug solution container is provided in an inverted posture such that the rubber stopper is located vertically below.

6. The drug solution transfer method according to claim 1, wherein
the drug solution container is elastically deformable.

7. The drug solution transfer method according to claim 6, wherein the drug solution container is a medical soft bag.

8. A drug solution transfer apparatus comprising:
a first retainer that retains a drug solution container provided with a rubber stopper;
a second retainer that retains a syringe provided with a needle;
a first shifter that shifts the first retainer or the second retainer;
a second shifter that shifts a plunger of the syringe; and
a controller that controls the first shifter and the second shifter independently from each other; wherein
the controller controls such that
the second shifter shifts the plunger in a state where the needle penetrates the rubber stopper so that drug solution is sucked from the drug solution container into the syringe,
the drug solution container and the syringe are relatively shifted to be distant from each other and stopped so as to locate a solution collection inlet at a tip of the needle inside the rubber stopper,
the second shifter pulls the plunger in the state where the solution collection inlet is located inside the rubber stopper so that an inner space of the syringe has negative pressure, and then
the drug solution container and the syringe are relatively shifted to be distant from each other so that the needle is extracted from the drug solution container.

9. The drug solution transfer apparatus according to claim 8, wherein
the drug solution container is provided in an inverted posture such that the rubber stopper is located vertically below.

10. The drug solution transfer apparatus according to claim 8, wherein
the drug solution container is elastically deformable.
